(19) United States
(12) Patent Application Publication
(10) Pub. No.: US 2012/0253904 A1
(43) Pub. Date: Oct. 4, 2012

(54) INTERNET-BASED METHOD AND SYSTEM FOR AFFILIATE MARKETING AND COMMISSION SHARING TO CREATE SALES LEADS

(76) Inventors: Gary C. Fishman, Naples, FL (US); Robert R. Hawthorne, The Woodlands, TX (US)

(21) Appl. No.: 13/072,888

(22) Filed: Mar. 28, 2011

(51) Int. Cl. G06Q 30/00

(52) U.S. Cl. 705/14.16

(57) ABSTRACT

A system and method for an internet-based affiliate marketing and commission sharing program that offers novel alternative incentives to potential customers and gives affiliates an opportunity to reach more customers by building affiliate networks to attract individuals who would normally not be interested in participating in a conventional affiliate marketing program.

### BACKGROUND OF THE INVENTION

This invention relates to affiliate marketing, more particularly, an internet-based method and system wherein individuals are able to sign up as affiliates of a service provider and refer potential customers and other potential affiliates to the service provider by offering special incentives to the potential customers and potential affiliates, thereby creating affiliate networks that are capable of contacting a larger portion of the market and transforming those contacts into sales leads for the service provider.

Affiliate marketing is a marketing practice wherein a business or service provider rewards one or more affiliates for each customer brought about by the affiliate's own marketing efforts. Conventional methods of affiliate marketing require affiliates to bring in multiple customers to earn larger commissions. This requires an aptitude for networking and sales on the affiliate's part. In addition, the only thing the affiliate has to offer a potential new client is a better product or service and/or a better price than that of a competing business or service provider. In essence, conventional affiliate marketing is no different than conventional sales and marketing in that the potential customer receives no lasting added incentive other than a lower price and/or a better product or service. In addition, conventional affiliate marketing limits the market that an affiliate can reach because the affiliate is limited only to how many new customers he or she can personally bring to a the business or service provider. This results in lower commission for the affiliate. Finally, most individuals are not good sales people and are thus scared away from participating in conventional affiliate marketing even though these individuals may know a small amount or even one potential customer that would buy services from them. Potential affiliates may also be scared away from conventional affiliate marketing programs because they have no technical knowledge of the products or services being marketed. Due to these facts, a service provider using a conventional affiliate marketing program misses the opportunity to recruit such individuals as affiliates and thus misses the opportunity to reach that one potential customer the individual may know.

Therefore, a need exists for a system and method for an internet-based affiliate marketing and commission sharing program that offers novel alternative incentives to potential customers and potential affiliates, gives affiliates an opportunity to reach more customers by building affiliate networks and attracts individuals who would normally not be interested in participating in a conventional affiliate marketing program to become affiliates.

The relevant prior art includes the following references:

| | | |
|---|---|---|
| Patent No. | Inventor | Issue/Publication Date |

(U.S. Patent References)

| | | |
|---|---|---|
| 7,500,608 | Bourne | Mar. 10, 2009 |
| 2008/0177669 | Marshall | Jul. 24, 2008 |
| 2008/0177656 | Sun et al. | Jul. 24, 2008 |
| 7,340,423 | Blagg et al. | Mar. 04, 2008 |
| 7,296,003 | Mersky et al. | Nov. 13, 2007 |
| 7,242,921 | Sullivan et al. | Jul. 10, 2007 |
| 7,224,778 | Aoki | May 29, 2007 |
| 7,200,578 | Paltenghe et al. | Apr. 03, 2007 |
| 2005/0097031 | Seo | May 05, 2005 |
| 2004/0083184 | Tsuei et al. | Apr. 29, 2004 |
| 2003/0037012 | Mersky et al. | Feb. 20, 2003 |
| 2002/0035538 | Moreau | Jul. 04, 2002 |
| 2002/0086660 | Sullivan et al. | Jul. 04, 2002 |
| 2002/0038233 | Shubov et al. | Mar. 28, 2002 |
| 6,363,356 | Horstmann | Mar. 26, 2002 |
| 2001/0011250 | Paltenghe et al. | Aug. 02, 2001 |
| 6,233,565 | Lewis et al. | May 15, 2001 |
| 6,070,150 | Remington et al. | May 30, 2000 |
| 5,884,272 | Walker et al. | Mar. 16, 1999 |

(Foreign Patent References)

| | | |
|---|---|---|
| WO2006/026418 | Krikorian et al. | Mar. 09, 2006 |

### SUMMARY OF THE INVENTION

The primary object of the present invention is to provide an internet-based method and system for affiliate marketing and commission sharing that offers novel alternative incentives to attract potential customers to a new service provider.

Another object of the present invention is to provide an internet-based method and system for affiliate marketing and commission sharing that induces affiliates to not only recruit new customers but to recruit new affiliates, thereby increasing the size of the market the service provider is capable of reaching.

An even further object of the present invention is to provide an internet-based method and system for affiliate marketing and commission sharing that will attract individuals who would normally not consider participating in conventional affiliate marketing programs.

Another object of the present invention is to provide an internet-based method and system for affiliate marketing and commission sharing that requires no experience in the industry being marketed to work as an affiliate.

The present invention fulfills the above and other objects by providing an internet-based method and system for affiliate marketing and commission sharing comprising a service provider that provides the opportunity for individuals to sign up as affiliates of the service provider on the service provider's website. As referred to herein, a service provider may be a company actually offering services, such as credit card companies, electronic payment processing companies, insurance companies, telephone companies, cable companies, satellite companies and so forth, or a company that operates the affiliate marketing and commission sharing program on behalf of the actual company that provides services. After an individual signs up as an affiliate of the service provider, he or she is required to sign up a limited number of customers and a predetermined number of affiliates. Customers are partnered with the affiliate who refers the customers. Each customer has the opportunity to receive a predetermined percentage of the commission its affiliate earns. Therefore, the number of customers that an affiliate may personally sign up and share commissions with are limited and preferably limited to a ratio of one customer to one affiliate. However, the ratio may be a ratio of more than one customer to a single affiliate. Each affiliate progresses through different levels of compensation depending upon how many additional affiliates he or she can sign up after signing up the required amount of customers and also depending on how many affiliates in his or her network signs up the required number of customers. If the affiliate has additional potential customers and has already signed up the maximum amount of allowed customers, then the affiliate may refer those potential customers to other affiliates in his or her affiliate network, thereby assisting those affiliates in progressing through the affiliate levels and increasing the amount of compensation that the referring affiliate will receive. Alternatively, the potential customer may sign up as an affiliate and be their own customer or refer their customer account to another affiliate

After an individual signs up as an affiliate, the service provider creates a website link for the new affiliate. The new affiliate then refers potential new customers and affiliates to the service provider's website using that link. The service provider's server then identifies that incoming customer or incoming affiliate as being referred by the new affiliate and adds the referred customer or referred affiliate to the new affiliate's affiliate network. The first affiliate and any affiliate in between a new affiliate earns percentages and/or bonuses from the new affiliates that are added into the affiliate network. In addition, each customer receives special incentives for switching to the new service provider. Specifically, the customer may receive a fixed percentage back of what the customer pays the service provider as a rebate or the customer may receive a fixed percentage of what its affiliate earns as commissions, whichever is greater. In the case of a company that operates the affiliate marketing and commission sharing program on behalf of the actual company that provides services, the customer may receive a fixed percentage back of the commission earned on the customer's account by the company operating the program or the customer may receive a fixed percentage of what its affiliate earns as commissions from the company operating the program, whichever is greater. The incentives ensure that the customer will always receive money back from the service provider in the form of a rebate or a percentage of commissions.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a flow chart showing a system and method for affiliate marketing and commission sharing to create sales leads of the present invention;

FIG. 2 is a flow chart showing a system and method for affiliate marketing and commission sharing to create sales leads of the present invention wherein the steps of an individual signing up as an affiliate using a service provider's website are shown;

FIG. 3 is a flow chart showing a system and method for affiliate marketing and commission sharing to create sales leads of the present invention wherein the steps of a customer signing up using a unique link are shown;

FIG. 4 is a flow chart showing a system and method for affiliate marketing and commission sharing to create sales leads of the present invention wherein the steps of an affiliate signing up using a unique link are shown;

FIG. 5 is a flow chart showing a system and method for affiliate marketing and commission sharing to create sales leads of the present invention wherein the steps of promoting the recruitment of affiliates are shown;

FIG. 6 is a flow chart showing a commission sharing and incentive program for customers of the present invention; and

FIG. 7 is an example of a computer environment, in which the method and system of the present invention operates.

### DESCRIPTION OF THE PREFERRED EMBODIMENTS

For purposes of describing the preferred embodiment, the terminology used in reference to the numbered accessories in the drawings is as follows:

| | |
|---|---|
| 1. | individual signs up as affiliate |
| 2. | affiliate webpage is created |
| 3. | unique link is created |
| 4. | affiliate makes offer to customer |
| 5. | offer to match rate |
| 6. | provides customer unique link |
| 7. | customer visits website |
| 8. | website information is provided |
| 9. | contact information is provided by customer |
| 10. | sales representative contacts customer |
| 11. | new account is open |
| 12. | previous rate is matched |
| 13. | receive rebate |
| 14. | receive percentage of affiliate's income from the service provider |
| 15. | sign up additional affiliates |
| 16. | affiliate network is created |
| 17. | progress through compensation levels |
| 18. | affiliate earns residual income |
| 19. | individual visits website |
| 20. | individual signs up |
| 21. | webpage is created |
| 22. | unique link is created |
| 23. | refer customer to website |
| 24. | customer uses unique link |
| 25. | website recognizes unique link |
| 26. | potential customer if provided form |
| 27. | customer provides contact information |
| 28. | refer individual to website |
| 29. | individual uses unique link |
| 30. | website recognizes unique link |
| 31. | individual signs up as affiliate |
| 32. | affiliate is added to referring affiliate's network |
| 33. | first affiliate signs up |
| 34. | first affiliate obtains maximum number of customers |
| 35. | potential customer wants to sign up |
| 36. | first affiliate has affiliates in affiliate network with no customers |
| 37. | first affiliate refers potential customer to affiliates in affiliate network |
| 38. | first affiliate has no affiliates in affiliate network |
| 39. | first affiliate recruits affiliates to join affiliate network |
| 40. | first affiliate refers potential customer to affiliates in affiliate network |
| 41. | everyone in first affiliate's affiliate network has the maximum |
| | number of customers |
| 42. | first affiliate recruits affiliates to join affiliate network |
| 43. | first affiliate refers potential customer to affiliates in affiliate network |
| 44. | affiliate |
| 45. | customer |
| 46. | customer sharing affiliate's commissions |
| 47. | affiliate earns monthly commission |
| 48. | service provider |
| 49. | service provider gives customer equal rate or discounted rate |
| 50. | customer receives rebate |
| 51. | customer receives percentage of affiliate's commissions |
| 52. | computer environment |
| 53. | server |
| 54. | remote device |
| 55. | internet |

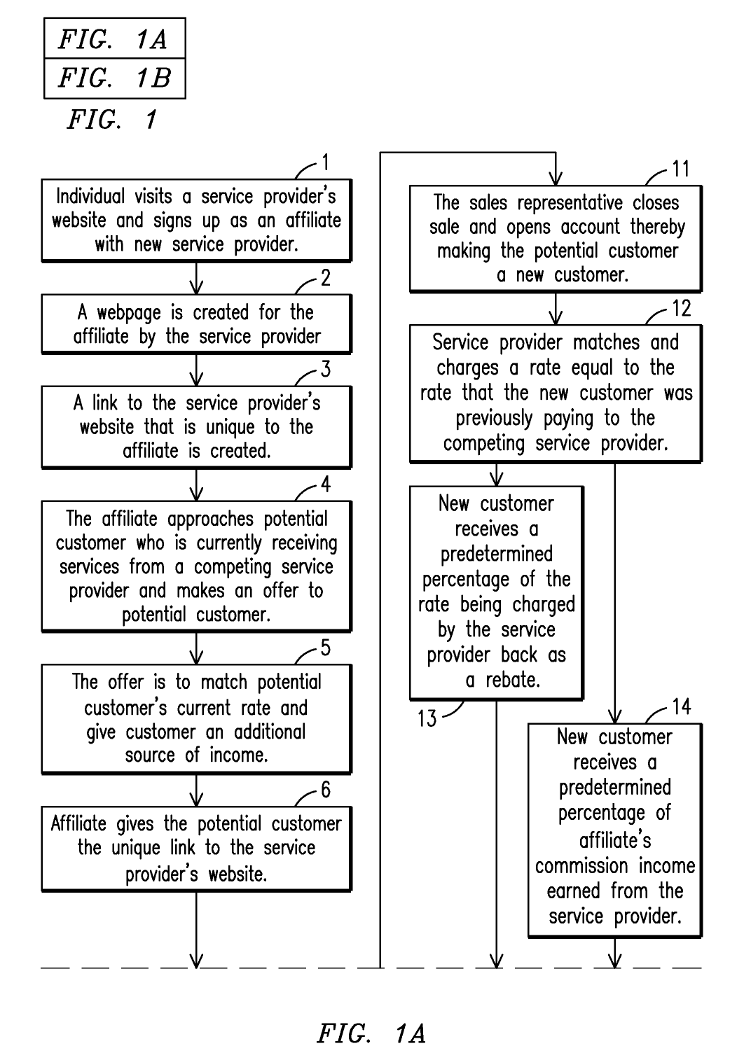

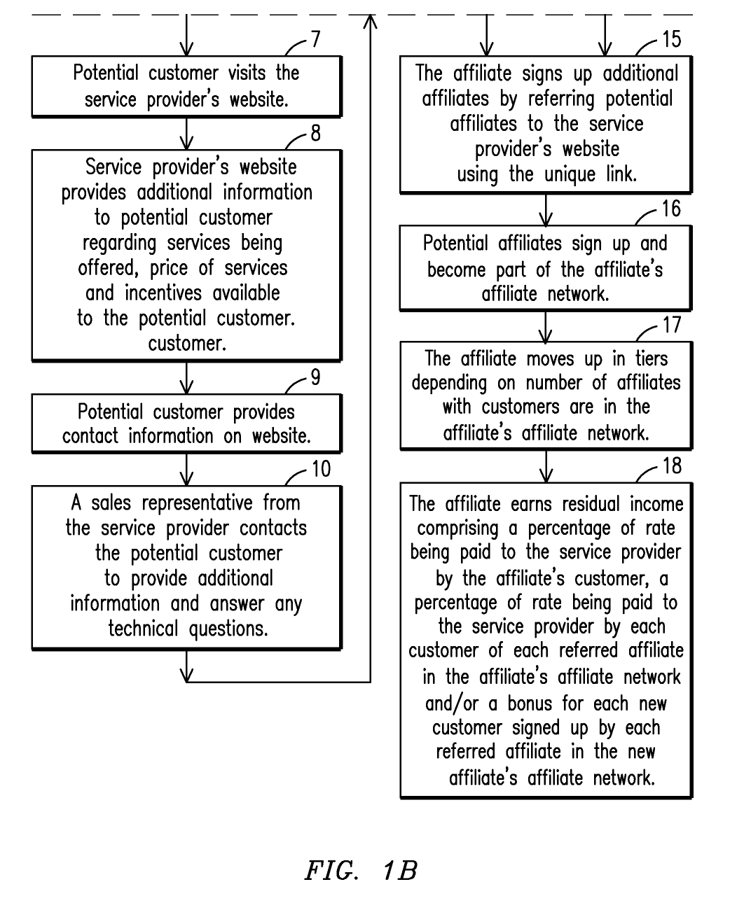

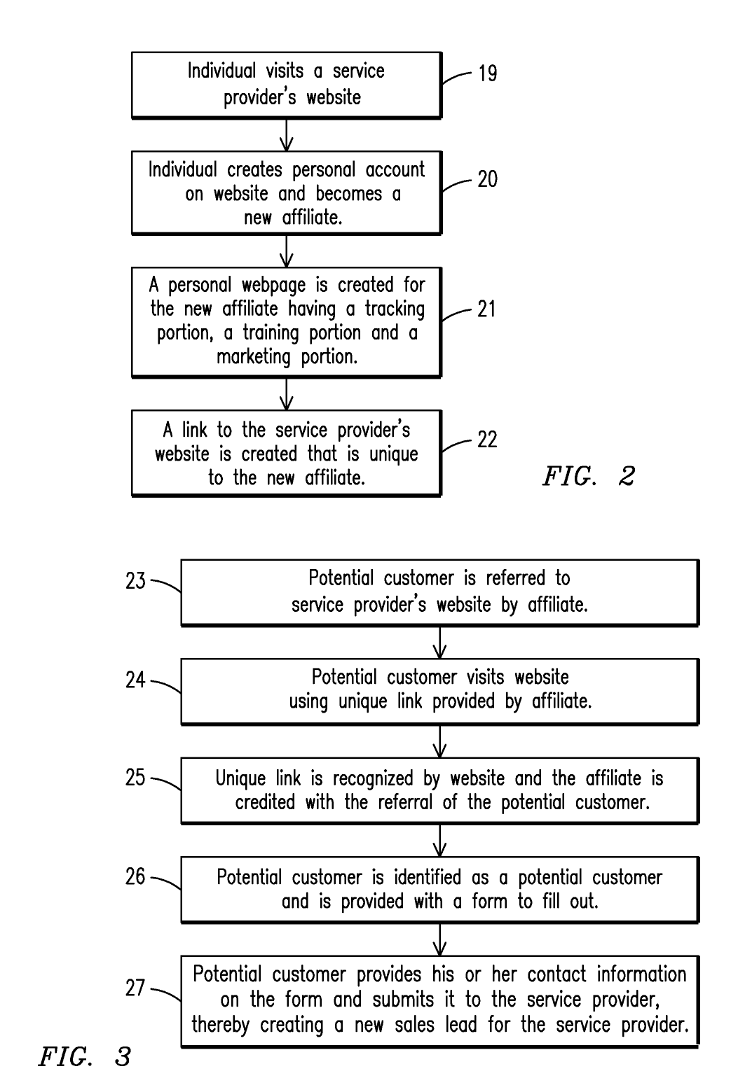

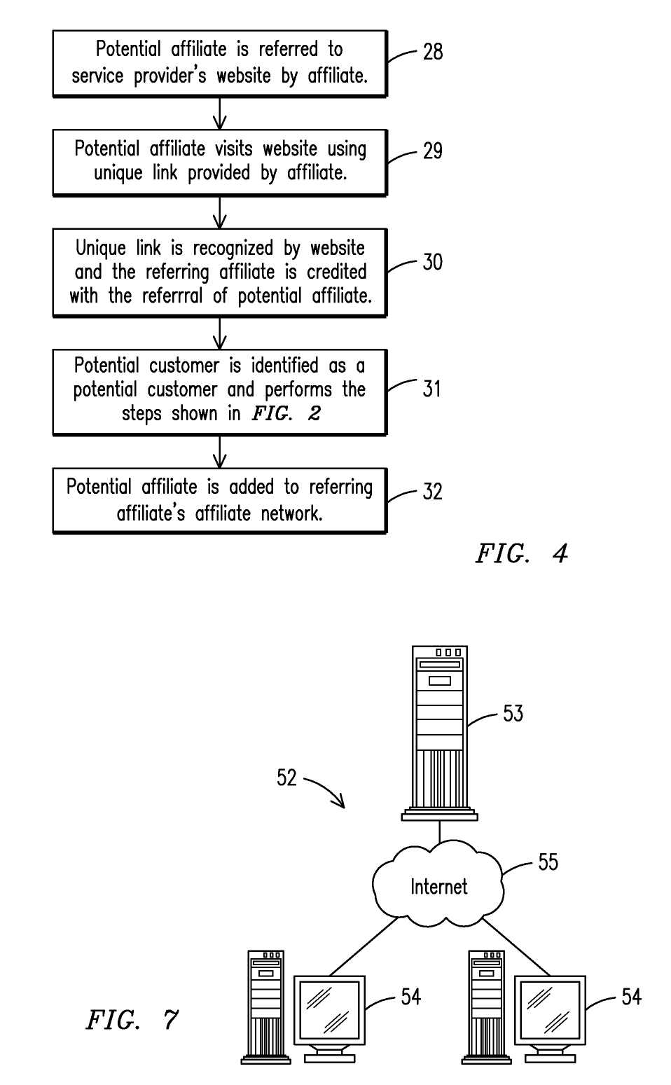

With reference to FIG. 1, a flow chart showing a system and method for affiliate marketing and commission sharing to create sales leads of the present invention is shown. First, an individual visits a service provider's website and signs up as a new affiliate with the service provider 1, as shown further in FIG. 2. Then, an affiliate webpage is created for the affiliate by the service provider on the service provider's website 2. Next, a unique link to the new service provider's website is created and assigned to the new affiliate 3. Then, the affiliate approaches a potential customer who is currently receiving services from a competing service provider and makes an offer to the potential customer 4. The offer is an offer that the affiliate's service provider will match the current rate being charged by the competing service provider and provide the potential customer with an additional income stream 5. Next, the affiliate gives the potential customer the unique link to the service provider's website 6. Then, the potential customer visits the service provider's website using the unique link 7. The service provider's website provides additional information to the potential customer regarding services being offered by the new service provider, price matching of competing competitors and incentives available to the potential customer 8. Next, the potential customer enters his or her contact information into the website, thereby creating a lead for the service provider 9. Then, a sales representative from the service provider contacts the potential customer to provide additional information and answer any technical questions 10. Next, the sales representative signs the potential customer up as a new customer and opens an account for the new customer that the affiliate will receive commissions from 11. Then, the service provider matches and charges a new rate that is equal to or lower than the rate that the new customer was previously paying to the competing service provider 12. Then, the customer has the option of receiving a predetermined percentage of a commission that is generated from their own account in the form of a rebate 13 or of receiving a predetermined percentage of the affiliate's total income earned from the service provider 14. Next, the affiliate signs up additional affiliates by referring potential affiliates to the new service provider's website using the unique link 15. Then, potential affiliates sign up and become part of the new affiliate's affiliate network 16. Next, the new affiliate moves up through compensation levels depending on how many affiliates with customers are in the affiliate's affiliate network 17. Finally, the new affiliate earns residual income comprising a percentage of a rate being paid to the new service provider by the affiliate's customer, a percentage of a rate being paid to the new service provider by each customer of each signed-up affiliate in the affiliate's affiliate network and/or a bonus for each new customer signed up by each affiliate in the new affiliate's affiliate network 18.

Now referring to FIG. 2, a flow chart showing a system and method for affiliate marketing and commission sharing to create sales leads of the present invention wherein the steps of an individual signing up as an affiliate using a service provider's website are shown. First, an individual visits the service provider's website 19. Then, the individual creates a personal account on the website by creating a username and password and providing the service provider with personal contact information, thereby becoming a new affiliate 20. Next, a personal webpage is created for the new affiliate having a tracking portion, a training portion and a marketing portion 21. Finally, a link to the service provider's website that is unique to the affiliate is created and supplied to the affiliate 22.

Now referring to FIG. 3, a flow chart showing a system and method for affiliate marketing and commission sharing to create sales leads of the present invention wherein the steps of a customer signing up using a unique link are shown. First, a potential customer is referred to the service provider's website 23 by an affiliate who gives the potential customer his or her unique link to the service provider's website. Then, the potential customer visits the website using the unique link 24. Next, the unique link is recognized by website and the referring affiliate is credited with the referral of the potential customer 25. Then, the potential customer is identified as a potential customer and is provided with a form to fill out 26. Next, the potential customer provides his or her contact information on the form and submits it to the new service provider, thereby creating a new lead for the new customer service provider to follow-up on 27. If the potential customer fails to use the unique link and visits the website using a general address, then the potential customer will still have the opportunity to provide the affiliate's name as a referring affiliate.

Now referring to FIG. 4, a flow chart showing a system and method for affiliate marketing and commission sharing to create sales leads of the present invention wherein the steps of an affiliate signing up using a unique link are shown. First, a potential affiliate is referred to the service provider's website 28 by an affiliate who gives the potential affiliate his or her unique link to the service provider's website. Then, the potential affiliate visits the website using the unique link 29. Next, the unique link is recognized by website and the referring affiliate is credited with the referral of the potential affiliate 30. Then, at 31 the potential affiliate is identified as a potential affiliate and performs the steps shown in FIG. 2. Next, the potential affiliate is added to the referring affiliate's affiliate network 32. If the potential affiliate fails to use the unique link and visits the website using a general address, then the potential affiliate will still have the opportunity to provide the referring affiliate's name.

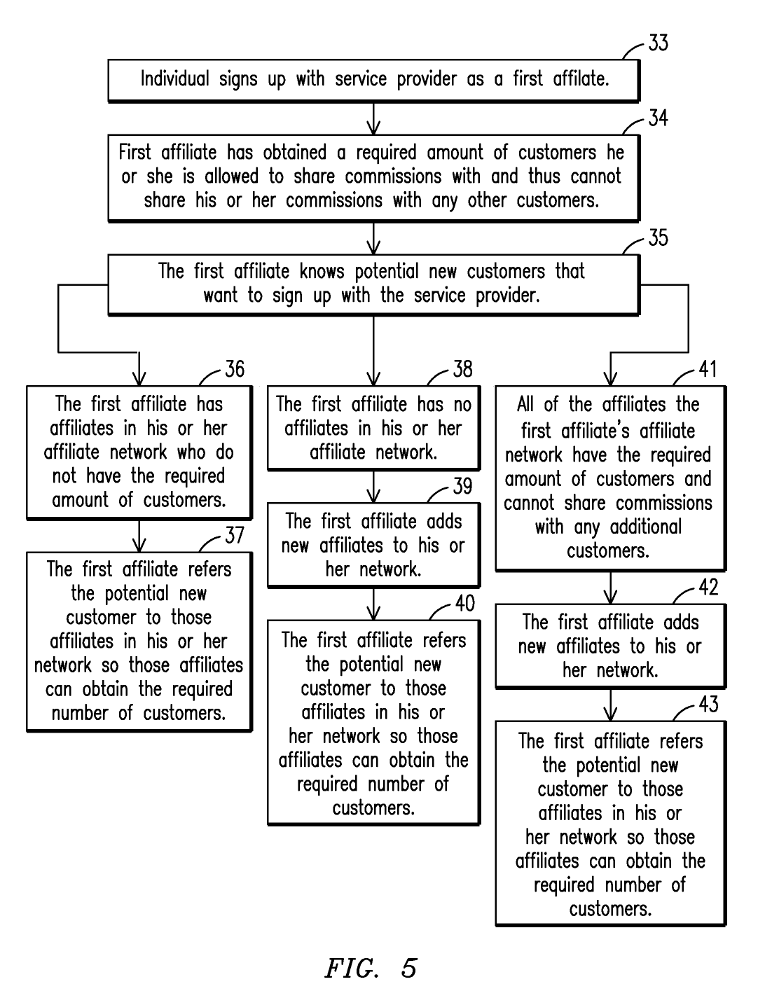

Now referring to FIG. 5, a flow chart showing a system and method for affiliate marketing and commission sharing to create sales leads of the present invention wherein the steps of promoting the recruitment of affiliates are shown. First, an individual signs up with a service provider as a first affiliate 33. Then, the first affiliate obtains a required number of customers with whom he or she is allowed to share his or her commissions 34. The first affiliate cannot share his or her commissions with any additional customers. Next, the first affiliate knows a potential new customer that wants to sign up with the service provider and share commissions with an affiliate 35. If the first affiliate has affiliates in his or her affiliate network who do not have the required number of customers 36, then the first affiliate refers the potential new customer to one of those affiliates so that affiliate can obtain the required number of customers 37. If the first affiliate has no affiliates in his affiliate network 38, then the first affiliate recruits new affiliates to his or her network 39 and the first affiliate refers the potential new customer to one of those new affiliates so those affiliates can obtain the required number of customers 40. If all of the affiliates in the first affiliate's affiliate network have the required amount of customers and cannot share commissions with any additional customers 41, then the first affiliate adds new affiliates to his or her affiliate network 42 and the first affiliate refers the potential new customer to those affiliates in his or her network so those affiliates can obtain the required number of customers 43. The system and method not only encourages affiliates to bring new customers to the service provider but also encourages affiliates to constantly add new affiliates to their affiliate network, thereby exposing the affiliate marketing program to more individuals who may know of new potential customers.

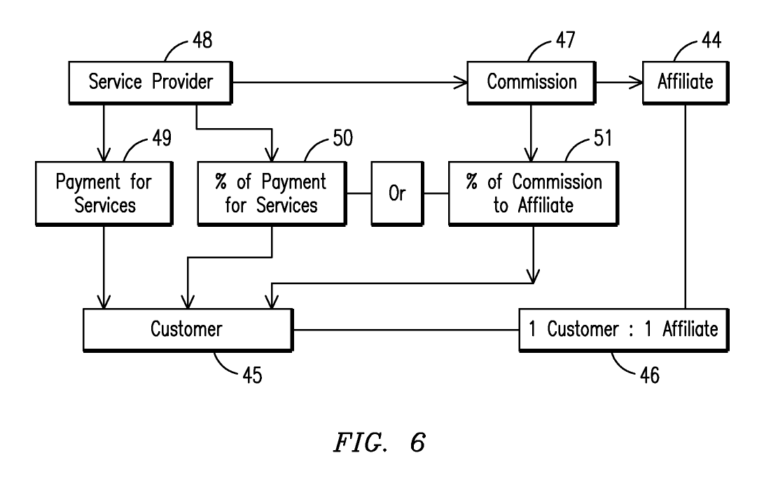

Now referring to FIG. 6, a flow chart showing commission sharing and incentive program for customers of the present invention is shown. First, an affiliate 44 has a limited number of customers 45 with whom he or she can share commissions 46, preferably only one customer 45 to one affiliate 44. The affiliate 44 earns a monthly or reoccurring commission 47 from the service provider 48. The monthly commission is based on the amount of money paid to the service provider 48 by the customer 45 and also on money earned by the service provider 48 from the affiliate's 44 affiliate network. As an incentive for buying services from the service provider 48, the customer 45 pays the service provider 48 a rate equal to or discounted from what the customer 45 was paying to a previous service provider 49. However, the customer 45 receives a percentage of the money the customer 45 pays to the service provider 48 back as a rebate 50 from the service provider 48 or the customer 45 receives a predetermined percentage of the affiliate's commission 51, whichever is greater.

Now referring to FIG. 7, an example of a computer environment 52, in which the method and system of the present invention operates is shown. A server 53 operated by the service provider hosts a website on which potential affiliates, affiliates, potential customers and customers may visit and/or log into via remote devices 54, such as computers, smart phones, IPads, and so forth, over the internet 55 using unique usernames and passwords. The affiliates use the computer environment to create sales leads by referring potential customers to the website with a unique link to the website, as shown in FIG. 1.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method for affiliate marketing and commission sharing to create sales leads comprising the following steps:
a. a service provider providing a website on a server for potential affiliates and potential customers to sign up on;
b. an individual visiting the website using a remote device;
c. said individual signing up as an affiliate of the service provider, thereby becoming an affiliate;
d. said affiliate approaching a potential customer;
e. said affiliate referring said potential customer to the service provider's website;
f. said potential customer visiting the service provider's website using a remote device;
g. said potential customer entering contact information into the remote device and transmitting said contact information to the service provider's website, thereby transforming said contact information into a sales lead for the service provider;
h. said potential customer being contacted by a sales representative from the service provider;
i. said sales representative offering a new rate that is equal to or lesser than a rate being paid by the potential customer to a competing service provider;
j. said sales representative offering to rebate a predetermined percentage of the new rate to the potential customer on a reoccurring basis;
k. said potential customer becoming an actual customer of the service provider; and
l. said service provider paying the affiliate a predetermined percentage of the new rate being paid to the service provider by the actual customer on a reoccurring basis.

2. The method for affiliate marketing and commission sharing to create sales leads of claim 1 further comprising a step after step c of:
the service provider creating a personal webpage for the affiliate.

3. The method for affiliate marketing and commission sharing to create sales leads of claim 1 further comprising a step after step c of:
the service provider creating a unique link to the service provider's website for the affiliate.

4. The method for affiliate marketing and commission sharing to create sales leads of claim 3 wherein step f further comprises:
the potential customer visiting the service provider's website using the affiliate's unique link, thereby allowing the service provider to recognize the potential new client as being referred by the affiliate.

5. The method for affiliate marketing and commission sharing to create sales leads of claim 1 wherein step j further comprises:
the sales representative offering the potential customer a predetermined percentage of the affiliate's total income earned from the service provider on a reoccurring basis as an alternative to the rebate of a predetermined percentage of the new rate to the potential customer on a reoccurring basis.

6. The method for affiliate marketing and commission sharing to create sales leads of claim 1 wherein step j further comprises:
the sales representative offering the potential customer the option of receiving the greater of a predetermined percentage of the affiliate's total income earned from the service provider on a reoccurring basis or the rebate of a predetermined percentage of the new rate to the potential customer on a reoccurring basis.

7. The method for affiliate marketing and commission sharing to create sales leads of claim 1 further comprising a step after step c of:
the affiliate referring one or more individuals to the service provider to sign up as affiliates, thereby becoming a referring affiliate.

8. The method for affiliate marketing and commission sharing to create sales leads of claim 7 further comprising a step of:
the one or more individuals signing up as affiliates of the service provider, thereby becoming new affiliates; and
the referring affiliate being given credit for referring the one or more new affiliates by adding the new affiliates to the referring affiliate's affiliate network.

9. The method for affiliate marketing and commission sharing to create sales leads of claim 8 further comprising a step of:
the referring affiliate receiving a predetermined percentage of any commissions earned by each new affiliate in the affiliate's affiliate network.

10. The method for affiliate marketing and commission sharing to create sales leads of claim 3 further comprising the steps of:
the affiliate referring one or more individuals to the service provider to sign up as affiliates;
the one or more individuals visiting the service provider's website using the affiliate's unique link, thereby allowing the service provider to recognize the one or more affiliates as being referred by the affiliate;
the one or more individuals signing up as affiliates of the service provider, thereby becoming new affiliates; and
the referring affiliate being given credit for referring the one or more new affiliates by adding the new affiliates to the referring affiliate's affiliate network.

11. The method for affiliate marketing and commission sharing to create sales leads of claim 10 further comprising a step of:
the referring affiliate receiving a predetermined percentage of any commissions earned by each new affiliate in the affiliate's affiliate network.

12. The method for affiliate marketing and commission sharing to create sales leads of claim 5 wherein:
only a limited number of customers may receive a predetermined percentage of the affiliate's total income earned from the service provider on a reoccurring basis.

13. The method for affiliate marketing and commission sharing to create sales leads of claim 12 wherein:
the affiliate has a maximum number of customers receiving a predetermined percentage of the affiliate's total income earned from the service provider on a reoccurring basis.

14. The method for affiliate marketing and commission sharing to create sales leads of claim 13 further comprising the steps of:
the affiliate referring one or more individuals to the service provider to sign up as affiliates, thereby becoming a referring affiliate;
the one or more individuals signing up as affiliates of the service provider, thereby becoming new affiliates;
the new affiliates being added to the referring affiliate's affiliate network;
the referring affiliate referring potential customers to one or more new affiliates;
and
the referring affiliate receiving a predetermined percentage of any commissions earned by the one or more new affiliates.

15. The method for affiliate marketing and commission sharing to create sales leads of claim 6 wherein:
only a limited number of customers may receive a predetermined percentage of the affiliate's total income earned from the service provider on a reoccurring basis.

16. The method for affiliate marketing and commission sharing to create sales leads of claim 15 wherein:
the affiliate has a maximum number of customers receiving a predetermined percentage of the affiliate's total income earned from the service provider on a reoccurring basis.

17. The method for affiliate marketing and commission sharing to create sales leads of claim 16 further comprising the steps of:
the affiliate referring one or more individuals to the service provider to sign up as affiliates, thereby becoming a referring affiliate;
the one or more individuals signing up as affiliates of the service provider, thereby becoming new affiliates;
the new affiliates being added to the referring affiliate's affiliate network;
the referring affiliate referring potential customers to one or more new affiliates;
and
the referring affiliate receiving a predetermined percentage of any commissions earned by the one or more new affiliates.

18. A system for affiliate marketing and commission sharing to create sales leads, said system comprising:
a service provider providing a website on a server for potential affiliates and potential customers to sign up on;
an individual visiting the website using a remote device;
said individual signing up as an affiliate of the service provider, thereby becoming an affiliate;
said affiliate approaching a potential customer;
said affiliate referring said potential customer to the service provider's website;
said potential customer visiting the service provider's website using a remote device;
said potential customer entering contact information into the remote device and transmitting said contact information to the service provider's website, thereby transforming said contact information into a sales lead for the service provider;
said potential customer being contacted by a sales representative from the service provider;
said sales representative offering a new rate that is equal to or lesser than a rate being paid by the potential customer to a competing service provider;
said sales representative offering to rebate a predetermined percentage of the new rate to the potential customer on a reoccurring basis;
said potential customer becoming an actual customer of the service provider; and
said service provider paying the affiliate a predetermined percentage of the new rate being paid to the service provider by the actual customer on a reoccurring basis.

19. The system for affiliate marketing and commission sharing to create sales leads of claim 18 further comprising:
the service provider creating a personal webpage for the affiliate.

20. The system for affiliate marketing and commission sharing to create sales leads of claim 18 further comprising:
the service provider creating a unique link to the service provider's website for the affiliate.

21. The system for affiliate marketing and commission sharing to create sales leads of claim 20 further comprising:
the potential customer visiting the service provider's website using the affiliate's unique link, thereby allowing the service provider to recognize the potential new client as being referred by the affiliate.

22. The system for affiliate marketing and commission sharing to create sales leads of claim 18 further comprising:
the sales representative offering the potential customer a predetermined percentage of the affiliate's total income earned from the service provider on a reoccurring basis as an alternative to the rebate of a predetermined percentage of the new rate to the potential customer on a reoccurring basis.

23. The system for affiliate marketing and commission sharing to create sales leads of claim 18 further comprising:
the sales representative offering the potential customer the option of receiving the greater of a predetermined percentage of the affiliate's total income earned from the service provider on a reoccurring basis or the rebate of a predetermined percentage of the new rate to the potential customer on a reoccurring basis.

24. The system for affiliate marketing and commission sharing to create sales leads of claim 18 further comprising:
the affiliate referring one or more individuals to the service provider to sign up as affiliates, thereby becoming a referring affiliate.

25. The system for affiliate marketing and commission sharing to create sales leads of claim 24 further comprising:
the one or more individuals signing up as affiliates of the service provider, thereby becoming new affiliates; and
the referring affiliate being given credit for referring the one or more new affiliates by adding the new affiliates to the referring affiliate's affiliate network.

26. The system for affiliate marketing and commission sharing to create sales leads of claim 25 further comprising:
the referring affiliate receiving a predetermined percentage of any commissions earned by each new affiliate in the affiliate's affiliate network.

27. The system for affiliate marketing and commission sharing to create sales leads of claim 20 further comprising:
the affiliate referring one or more individuals to the service provider to sign up as affiliates;
the one or more individuals visiting the service provider's website using the affiliate's unique link, thereby allowing the service provider to recognize the one or more affiliates as being referred by the affiliate;
the one or more individuals signing up as affiliates of the service provider, thereby becoming new affiliates; and
the referring affiliate being given credit for referring the one or more new affiliates by adding the new affiliates to the referring affiliate's affiliate network.

28. The system for affiliate marketing and commission sharing to create sales leads of claim 27 further comprising:
the referring affiliate receiving a predetermined percentage of any commissions earned by each new affiliate in the affiliate's affiliate network.

29. The system for affiliate marketing and commission sharing to create sales leads of claim 22 wherein:
only a limited number of customers may receive a predetermined percentage of the affiliate's total income earned from the service provider on a reoccurring basis.

30. The system for affiliate marketing and commission sharing to create sales leads of claim 29 wherein:
the affiliate has a maximum number of customers receiving a predetermined percentage of the affiliate's total income earned from the service provider on a reoccurring basis.

31. The system for affiliate marketing and commission sharing to create sales leads of claim 30 further comprising:
the affiliate referring one or more individuals to the service provider to sign up as affiliates, thereby becoming a referring affiliate;
the one or more individuals signing up as affiliates of the service provider, thereby becoming new affiliates;
the new affiliates being added to the referring affiliate's affiliate network;
the referring affiliate referring potential customers to one or more new affiliates;
and
the referring affiliate receiving a predetermined percentage of any commissions earned by the one or more new affiliates.

32. The system for affiliate marketing and commission sharing to create sales leads of claim 23 wherein:
only a limited number of customers may receive a predetermined percentage of the affiliate's total income earned from the service provider on a reoccurring basis.

33. The system for affiliate marketing and commission sharing to create sales leads of claim 32 wherein:
the affiliate has a maximum number of customers receiving a predetermined percentage of the affiliate's total income earned from the service provider on a reoccurring basis.

34. The system for affiliate marketing and commission sharing to create sales leads of claim 33 further comprising:
the affiliate referring one or more individuals to the service provider to sign up as affiliates, thereby becoming a referring affiliate;
the one or more individuals signing up as affiliates of the service provider, thereby becoming new affiliates;
the new affiliates being added to the referring affiliate's affiliate network;
the referring affiliate referring potential customers to one or more new affiliates;
and
the referring affiliate receiving a predetermined percentage of any commissions earned by the one or more new affiliates.
